(19) United States
(12) Patent Application Publication
(10) Pub. No.: US 2011/0157082 A1
(43) Pub. Date: Jun. 30, 2011

(54) Matrix Resistive Touch Panel and Design Method Thereof

(75) Inventors: Yung-Chang Lin, Taichung City (TW); Ming-Chuan Lin, Taichung City (TW); Lin Lin, Taichung City (TW); Chih-Chiang Lin, Taichung City (TW)

(73) Assignee: WINTEK CORPORATION, Taichung (TW)

(21) Appl. No.: 12/978,789

(22) Filed: Dec. 27, 2010

(30) Foreign Application Priority Data
Dec. 31, 2009 (TW) 98146272

(51) Int. Cl. G06F 3/045

(52) U.S. Cl. 345/174

(57) ABSTRACT

A matrix resistive touch panel including a plurality of first sensing electrodes, a plurality of second sensing electrodes, a control circuit and a compensating circuit is provided. Each first sensing electrode has a first end and a second end. Each second sensing electrode has a third end and a fourth end. The compensating circuit is electrically connected to the control circuit, the first and the second ends of the first sensing electrodes, and the third and the fourth ends of the second sensing electrodes. The compensating circuit is used for equating a plurality of first impedances between the first ends and the control circuit, equating a plurality of second impedances between the second ends and the control circuit, equating a plurality of third impedances between the third ends and the control circuit, and equating a plurality of fourth impedances between the fourth ends and the control circuit.

This application claims the benefit of Taiwan application Serial No. 98146272, filed Dec. 31, 2009, the subject matter of which is incorporated herein by reference.

### BACKGROUND OF THE INVENTION

1. Field of the Invention

The invention relates in general to a touch panel, and more particularly to a matrix resistive touch panel and a design method thereof.

2. Description of the Related Art

Examples of most commonly used touch technologies include the capacitive touch technology and the resistive touch technology. Recently, the matrix touch technology of the resistive touch technology, being capable of producing complete linear data, already possesses multi touch function. However, due to the limited accuracy in the traces being manufactured, the touch panel may have different voltages at the same horizontal positions or the same vertical positions. Consequently, the linearity of the touch panel is affected, and the detected position of the touch point may be biased.

### SUMMARY OF THE INVENTION

The invention is directed to a matrix resistive touch panel and a design method thereof. The linearity of the panel is improved through the disposition of the compensating circuit.

According to a first aspect of the present invention, a matrix resistive touch panel including a plurality of first sensing electrodes, a plurality of second sensing electrodes, a control circuit and a compensating circuit is provided. The first sensing electrodes are disposed in parallel, wherein each of the first sensing electrodes has a first end and a second end. The second sensing electrodes are disposed in parallel, and the extending direction of the second sensing electrodes is perpendicular to that of the first sensing electrodes, wherein each of the second sensing electrodes has a third end and a fourth end. The compensating circuit is electrically connected to the control circuit, the first and the second ends of the first sensing electrodes, and the third and the fourth ends of the second sensing electrodes. The compensating circuit is used for equating a plurality of first impedances between the first ends and the control circuit, equating a plurality of second impedances between the second ends and the control circuit, equating a plurality of third impedances between the third ends and the control circuit, and equating a plurality of fourth impedances between the fourth ends and the control circuit.

According to a second aspect of the present invention, a design method of a matrix resistive touch panel is provided. The design method includes the following steps: A sensing electrode configuration of a matrix resistive touch panel is provided, wherein the sensing electrode configuration includes a plurality of first sensing electrodes and a plurality of second sensing electrodes, each first sensing electrode has a first end and a second end, and each second sensing electrode has a third end and a fourth end. A first impedances between the first ends and a plurality of first conductive wires in a control end of the matrix resistive touch panel are estimated, a second impedance s between the second ends and a plurality of second conductive wires in the control end are estimated, a third impedances between the third ends and a plurality of third conductive wires in the control end are estimated, and a fourth impedances between the fourth ends and a plurality of fourth conductive wires in the control end are estimated. A plurality of compensating impedances of the first impedances, the second impedances, the third impedances and the fourth impedances are calculated according to impedance differences of the first impedances, the second impedances, the third impedances and the fourth impedances. The first impedances, the second impedances, the third impedances and the fourth impedances are correspondingly adjusted through the compensating impedances for equating the first impedances between the first ends and the control end, equating the second impedances between the second end and the control end, equating the third impedances between the third end and the control end, and equating between the fourth impedances between the fourth end and the control end.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIGS. 1A and 1B are diagrams of a matrix resistive touch panel according to an embodiment of the invention;

FIGS. 2 and 3 are diagrams of a compensating circuit being disposed on a circuit board;

FIG. 4 is a diagram of a compensating circuit with different wires;

FIG. 5 shows a flowchart of a design method of a matrix resistive touch panel according to an embodiment of the invention; and

FIGS. 6A and 6B are diagrams showing a compensating circuit with a plurality of resistive elements.

### DETAILED DESCRIPTION OF THE INVENTION

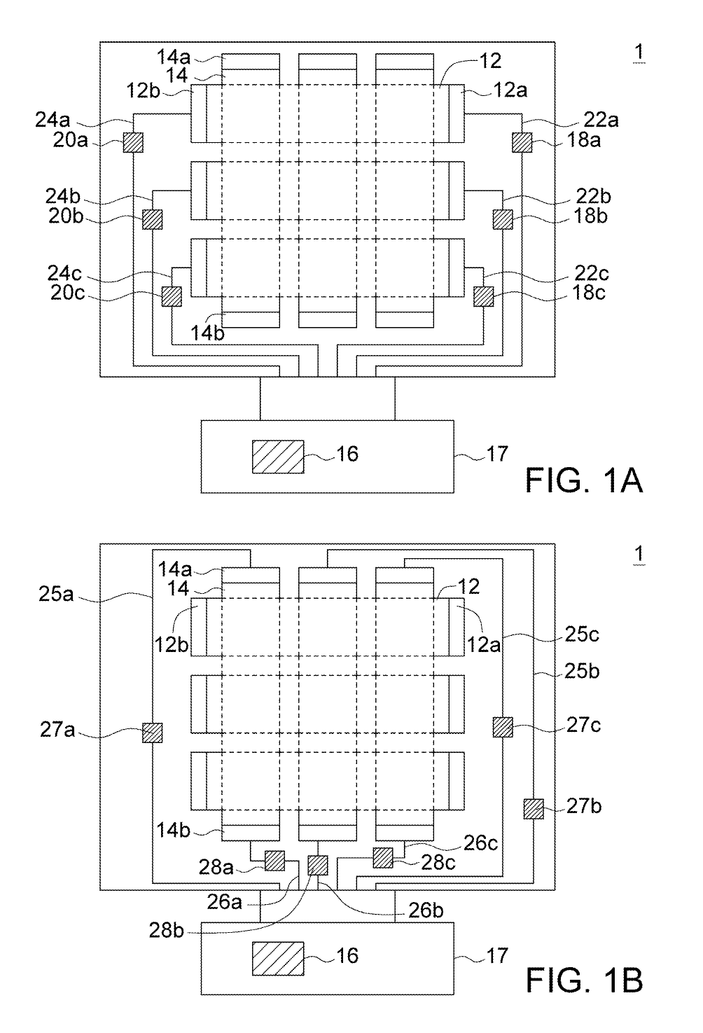

Referring to FIGS. 1A and 1B, diagrams of a matrix resistive touch panel according to an embodiment of the invention are shown. As indicated in the diagrams, the matrix resistive touch panel 1 includes a plurality of first sensing electrodes 12, a plurality of second sensing electrodes 14, a control circuit 16 and a compensating circuit. For simplification purpose, FIGS. 1A and 1B illustrate only three first sensing electrodes 12 and three second sensing electrodes 14, and the dispositions of the first sensing electrodes 12 and the second sensing electrodes 14 connecting to the conductive wires are illustrated in the two diagrams respectively. The first sensing electrodes 12 are disposed in parallel, and are extended in a horizontal direction of the diagram. Each of the first sensing electrodes 12 has a first end 12a and a second end 12b. The second sensing electrodes 14 are disposed in parallel, and the extending direction of the second sensing electrodes 14 is perpendicular to that of the first sensing electrodes 12. Each of the second sensing electrodes 14 has a third end 14a and a fourth end 14b. The first sensing electrodes 12 and the second sensing electrodes 14 are arranged in a matrix like a chessboard, so the touch panel 1 can support multi touch when being pressed.

The control circuit 16 is disposed on a circuit board 17. The compensating circuit is electrically connected to the control circuit 16, the first end 12a and the second end 12b of the first sensing electrodes 12, and the third end 14a and the fourth end 14b of the second sensing electrodes 14.

The compensating circuit is used for equating a plurality of first impedances between the first ends 12a and the control circuit 16, equating a plurality of second impedances between the second end 12b and the control circuit 16, equating a plurality of third impedances between the third end 14a and the control circuit 16, and equating a plurality of fourth impedances between the fourth end 14b and the control circuit 16. Different designs of the compensating circuit are disclosed in following diagrams.

As indicated in FIG. 1A, the compensating circuit of the present embodiment of the invention includes a plurality of compensating elements, such as the compensating elements 18a,18b and 18c electrically connected to each first end 12a, and the compensating elements 20a, 20b and 20c electrically connected to each second end 12b. Preferably, the compensating elements 18a, 18b and 18c are connected to the first conductive wires 22a, 22b and 22c respectively, and the compensating elements 20a, 20b, and 20c are connected to the second conductive wires 24a, 24b and 24c respectively.

The disposition of electrically connecting other compensating elements to the third end 14a and the fourth end 14b is illustrated in FIG. 1B, in which the third conductive wires 25a, 25b and 25c electrically connect the control circuit 16 to the third end 14a, and the fourth conductive wires 26a, 26b and 26c electrically connect the fourth end 14b to the control circuit 16. The compensating elements 27a, 27b and 27c are electrically connected to the third conductive wires 25a, 25b and 25c respectively, and the compensating elements 28a, 28b and 28c are electrically connected to the fourth conductive wires 26a, 26b and 26c respectively.

Let the first conductive wires 22a, 22b and 22c be taken for example. The positions of the first end 12a of the first sensing electrodes 12 on the touch panel 1 are different, so the distances between the first ends 12a and the control circuit 16 are different, and the lengths of the first conductive wires 22a, 22b and 22c are different. The volume of the impedance of the conductive wires has much to do with the length and the cross-section area of the wire. For example, the volume of the impedance is proportional to the wire length but is inversely proportional to the wire width. Suppose the conductive wires have the same cross-section area, when the first conductive wires 22a, 22b and 22c have different lengths, the impedances of the first conductive wires will be different. Thus, the compensating elements 18a, 18b and 18c cascaded to the first conductive wires 22a, 22b and 22c respectively for compensating the impedance differences between the conductive wires for equating the first impedances between each first end 12a and the control circuit 16.

Likewise, the compensating elements 20a, 20b, 20c are cascaded to the second conductive wires 24a, 24b and 24c for compensating the impedance difference between the conductive wires, so that the first sensing electrodes 12 will have the same voltage at the horizontal positions, largely increasing the linear accuracy in the horizontal direction.

Similarly, the impedance differences of the conductive wires electrically connected to third ends 14a and the fourth ends 14b may also be eliminated by the compensating element in the same manner, so that the linear accuracy in the vertical direction can be controlled. Preferably, the compensating elements are realized by voltage-drop elements, such as the resistive element with different resistances.

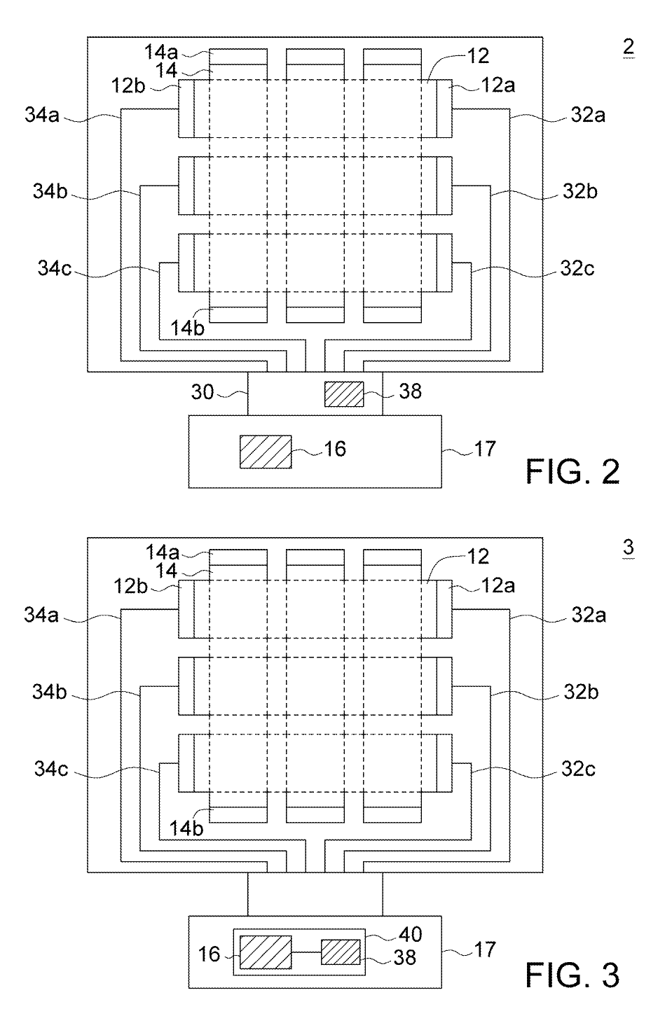

Referring to FIGS. 2 and 3, diagrams showing a compensating circuit being disposed on a circuit board are shown. As indicated in FIG. 2, the circuit board 17 and the body of the matrix resistive touch panel 2 are connected through a flexible circuit board 30, wherein the compensating circuit 38 may be directly disposed on the flexible circuit board 30. The compensating circuit 38 includes a plurality of compensating elements (such as the compensating elements 18a of FIG. 1A). After the control circuit 16 emits a voltage signal, the voltage signal pass through the compensating circuit 38 first, and then pass through the first conductive wires 32a, 32b and 32c, the second conductive wires 34a, 34b and 34c and other wires, and at last reach the first end 12a, the second end 12b, the third end 14a and the fourth end 14b. Besides, the compensating circuit 38 and the control circuit 16 can be concurrently disposed in the circuit board 17. Or, the compensating circuit 38 and the control circuit 16 can be concurrently disposed in the flexible circuit board 30.

Referring to FIG. 3. The matrix resistive touch panel 3 is different from the matrix resistive touch panel 2 in that: on the part of the matrix resistive touch panel 3, the compensating circuit 38 and the control circuit 16 are directly integrated in one single integrated circuit 40 which is disposed on the circuit board 17.

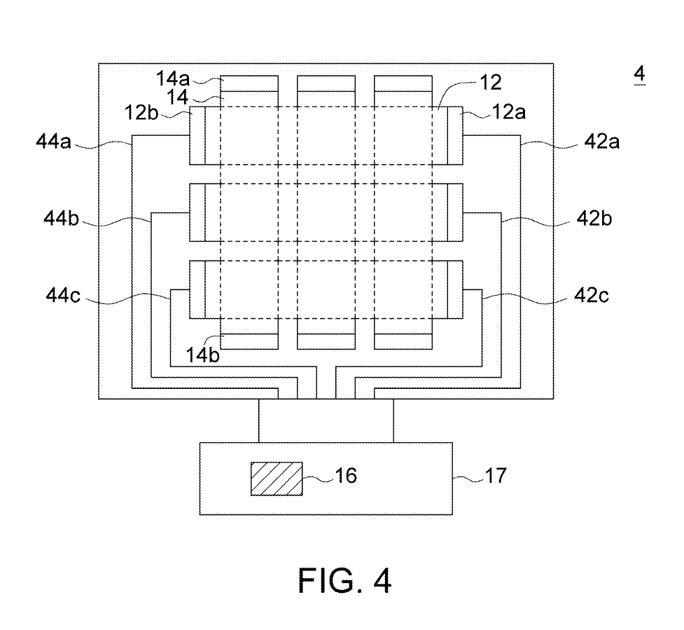

Referring to FIG. 4, a diagram of a compensating circuit with different wires is shown. The compensating circuit of the matrix resistive touch panel 4 is formed by the first conductive wires 42a, 42b and 42c electrically connected to first end 12a, the second conductive wires 44a, 44b and 44c electrically connected to the second end 12b, and a plurality of wires electrically connected to the third end 14a and the fourth end 14b. Since the impedance is proportional to the conductive wires (length/width), all the conductive wires connected to the same end can have the same ratio of length and the cross-section area (or width) so as to produce the same impedance.

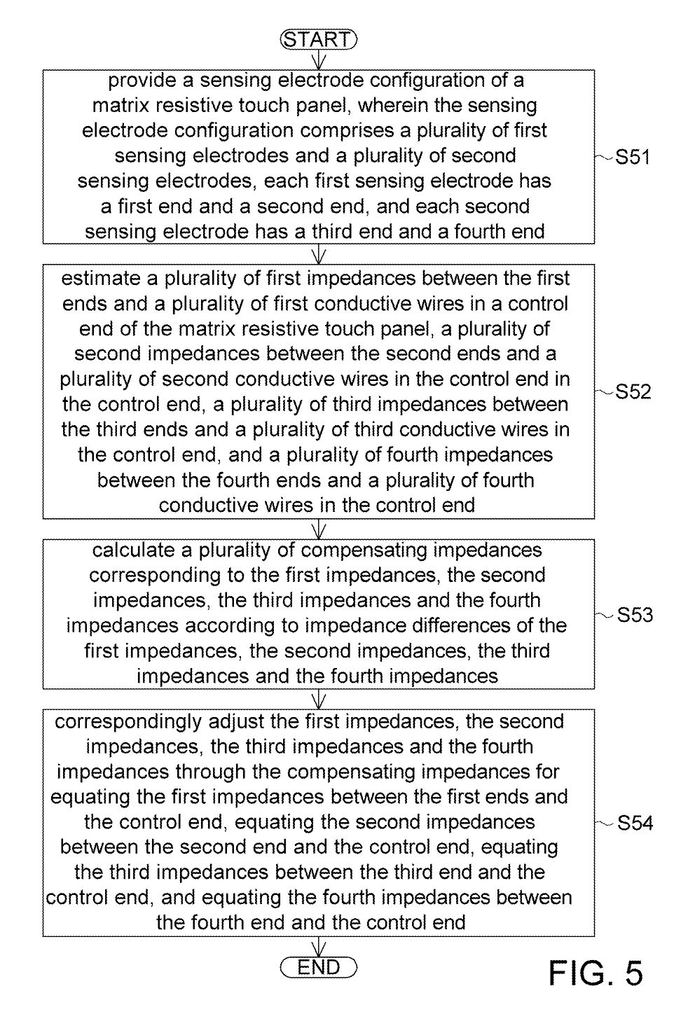

The present embodiment of the invention further discloses a design method of a matrix resistive touch panel. Referring to FIG. 5, a flowchart of a design method of a matrix resistive touch panel according to an embodiment of the invention is shown. The method includes steps S51˜554. In step S51, a sensing electrode configuration of a matrix resistive touch panel is provided, wherein the sensing electrode configuration includes a plurality of first sensing electrodes and a plurality of second sensing electrodes, each first sensing electrode has a first end and a second end, and each second sensing electrode has a third end and a fourth end.

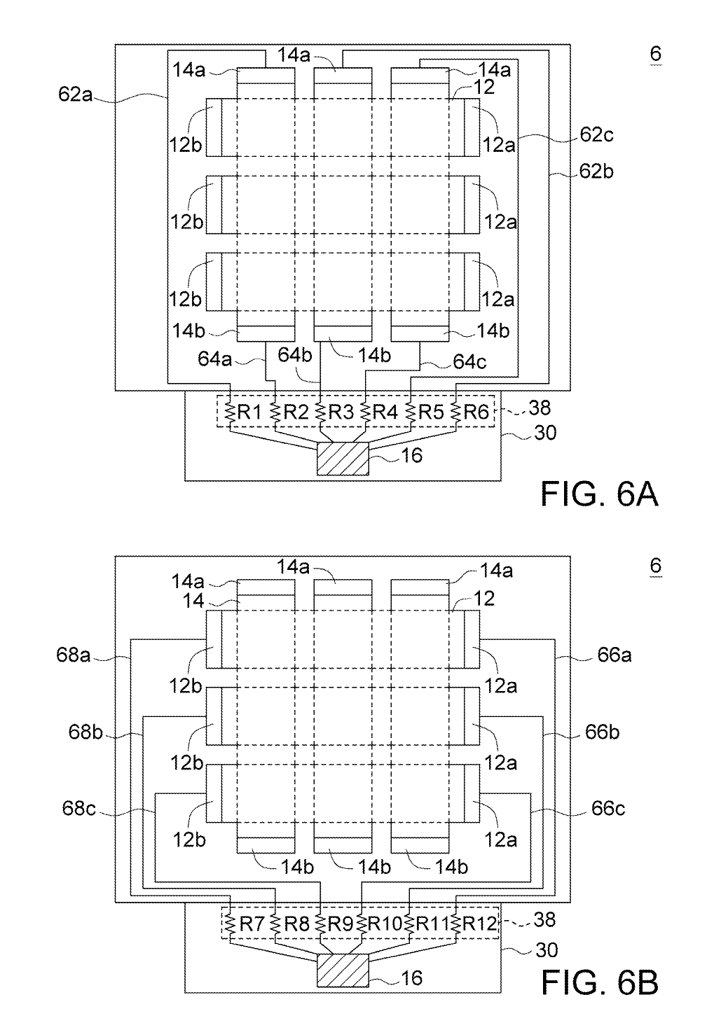

Referring to FIGS. 6A and 6B, diagrams showing a compensating circuit with a plurality of resistive elements are shown. FIGS. 6A and 6B are for assisting the elaboration of the design method of FIG. 5, not for limiting the scope of protection of the invention. As indicated in FIGS. 6A and 6B, the sensing electrode configuration of the matrix resistive touch panel 6 includes the first sensing electrodes 12 and the second sensing electrodes 14 perpendicular thereto, wherein each first sensing electrode 12 has a first end 12a and a second end 12b, and each second sensing electrode 14 has a third end 14a and a fourth end 14b.

Next, in step S52, each the first sensing electrode 12 and each the second sensing electrode 14 are electrically connected to the control circuit 16 through different conductive wires. For simplification purpose, the first sensing electrodes 12 and the second sensing electrodes 14 and the conductive wires connected thereto are illustrated in two diagrams. As indicated in FIG. 6A, the third ends 14a of the second sensing electrodes 14 are electrically connected to the third conductive wires 62a, 62b and 62c respectively, and the fourth ends 14b of the second sensing electrodes 14 are electrically connected to the fourth conductive wires 64a, 64b and 64c. As indicated in FIG. 6B, the first ends 12a of the first sensing electrodes 12 are electrically connected to the first conductive wires 66a, 66b and 66c respectively, and the second ends 12b are electrically connected to the second conductive wires 68a, 68b and 68c respectively.

Since the disposition of the conductive wires can be planned in advance, the predetermined impedance of each conductive wire can be calculated in dependence of the design of the predetermined length and width of the wire. For example, the first impedance of each of the first conductive wires 66a, 66b and 66c may be obtained through calculation in advance.

Then, in step S53, a plurality of compensating impedance corresponding to the first impedances, the second impedances, the third impedances and the fourth impedances may be calculated according to the impedance differences of the first impedances, the second impedances, the third impedances and the fourth impedances. Let the third conductive wires 62a, 62b and 62c of FIG. 6A be taken for example. Suppose each conductive wire has the same cross-section area. Since the lengths of the three conductive wires are different, the impedances of the conductive wires are substantially different, and the impedance differences of each the conductive wires may thus be estimated. The impedance differences of other conductive wires may be obtained in the same manner.

Afterwards, in step S54, the corresponding first impedances, second impedances, third impedances and fourth impedances are adjusted through the compensating impedances for equating the impedance between the corresponding end (one of the first end 12a, the second end 12b, the third end 14a and the fourth end 14b) and the control end.

Also, suitable compensating elements can be selected according to the volume of the compensating impedances and then lapped to each conductive wire. The compensating element can be realized by a voltage-drop element for appropriately adjusting the volume of the voltage. Take the first conductive wires 66a, 66b and 66c for example. Each of the first conductive wires 66a, 66b and 66c may be lapped to a first voltage-drop element.

Let the resistive element be taken for example. The resistive element can be used for directly compensating the impedance of each conductive wire. As indicated in FIGS. 6A and 6B, the compensating circuit 38 includes a plurality of resistive elements, such as resistive elements R1˜R12, which are concurrently disposed on the flexible circuit board 30 with the control circuit 16. The third conductive wires 62a, 62b and 62c are electrically connected to the control circuit 16 through the resistive element R1, R5 and R6 respectively. The fourth conductive wires 64a, 64b and 64c are electrically connected to the control circuit 16 through the resistive element R2, R3, R4 respectively. The first conductive wires 66a, 66b and 66c are electrically connected to the control circuit 16 through the resistive element R12, R11 and R10 respectively. The second conductive wires 68a, 68b and 68c are electrically connected to the control circuit 16 through the resistive element R7, R8 and R9 respectively.

Thus, the first impedances between the first ends 12a and the control circuit 16 are the sum of the impedances of the first conductive wires and the resistive elements connected thereto, and the second impedances between the second ends 12b and the control circuit 16, the third impedances between the third ends 14a and the control circuit 16, and the fourth impedances between the fourth ends 14b and the control circuit 16 can be obtained in the same manner. Through the disposition of the resistive elements R1˜R12, the voltage signal transmitted from the control circuit 16 to the first ends 12a, the second ends 12b, the third ends 14a and the fourth ends 14b will not vary with impedance difference, so that the voltages at the same horizontal positions and the same vertical positions can be equal, and the linearity of the touch panel can be accurately controlled.

According to the matrix resistive touch panel and the design method thereof disclosed in above embodiments of the invention, the impedance of each conductive wire is estimated in advance, and then appropriate compensation is designed according to the impedance for equating the impedances of the sensing electrodes of the conductive wires electrically connecting the control end to the touch panel so as to maintain the accuracy in the linearity of the touch panel. The design of compensation can be realized by adding extra voltage-drop elements (such as resistive elements) or directly adjusting the parameters of the length and the width of the conductive wires, wherein the compensation can be implemented on the body of the touch panel or through connected circuit board, or directly integrated with the control circuit. Thus, the conductive wires have larger variances, and the conformity rate in the manufacturing process of the panel is increased.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A matrix resistive touch panel, comprising:
a plurality of first sensing electrodes disposed in parallel, wherein each first sensing electrode has a first end and a second end;
a plurality of second sensing electrodes disposed in parallel, wherein the extending directions of the second sensing electrodes are perpendicular to that of the first sensing electrodes, and each second sensing electrode has a third end and a fourth end;
a control circuit; and
a compensating circuit electrically connected to the control circuit, the first ends, the second ends, the third ends and the fourth ends, wherein the compensating circuit is used for equating a plurality of first impedances between the first ends and the control circuit, equating a plurality of second impedances between the second ends and the control circuit, equating a plurality of third impedances between the third ends and the control circuit, and equating a plurality of fourth impedances between the fourth ends and the control circuit.

2. The matrix resistive touch panel according to claim 1, wherein the compensating circuit comprises:
a plurality of first conductive wires electrically connected to the control circuit and the first ends, wherein the first impedances of the first conductive wires are equal;
a plurality of second conductive wires electrically connected to the control circuit and the second ends, wherein the second impedances of the second conductive wires are equal;
a plurality of third conductive wires electrically connected to the control circuit and the third ends, wherein the third impedances of the third conductive wires are equal; and
a plurality of fourth conductive wires electrically connected to the control circuit and the fourth ends, wherein the fourth impedances of the fourth conductive wires are equal.

3. The matrix resistive touch panel according to claim 2, wherein the first conductive wires have different lengths and different cross-section areas, the second conductive wires have different lengths and different cross-section areas, the third conductive wires have different lengths and different cross-section areas, and the fourth conductive wires have different lengths and different cross-section areas.

4. The matrix resistive touch panel according to claim 1, further comprising a plurality of conductive wires for electrically connecting the compensating circuit to the first ends, the second ends, the third ends and the fourth ends, wherein the compensating circuit comprises:
a plurality of first voltage-drop elements electrically connected to the conductive wires and the control circuit, and the first impedances formed by the first voltage-drop elements and the conductive wires connected thereto are equal;
a plurality of second voltage-drop elements electrically connected to the conductive wires and the control circuit, and the second impedances formed by the second voltage-drop elements and the conductive wires connected thereto are equal;
a plurality of third voltage-drop elements electrically connected to the conductive wires and the control circuit, and the third impedances formed by the third voltage-drop elements and the conductive wires connected thereto are equal; and
a plurality of fourth voltage-drop elements, electrically connected to the conductive wires and the control circuit, and the fourth impedances formed by the fourth voltage-drop elements and the conductive wires connected thereto are equal.

5. The matrix resistive touch panel according to claim 4, wherein the cross-section areas of the conductive wires are equal.

6. The matrix resistive touch panel according to claim 4, wherein each of the first voltage-drop elements, each of the second voltage-drop elements, each of the third voltage-drop elements and each of the fourth voltage-drop elements are a resistive element.

7. The matrix resistive touch panel according to claim 4, further comprising a circuit board, wherein the first voltage-drop elements, the second voltage-drop elements, the third voltage-drop elements and the fourth voltage-drop elements are disposed on the circuit board.

8. The matrix resistive touch panel according to claim 7, wherein the circuit board is a flexible circuit board.

9. The matrix resistive touch panel according to claim 7, wherein the control circuit is disposed on the circuit board.

10. The matrix resistive touch panel according to claim 1, further comprising an integrated circuit, wherein the control circuit and the compensating circuit are integrated in the integrated circuit.

11. A design method of a matrix resistive touch panel, comprising:
providing a sensing electrode configuration of a matrix resistive touch panel, wherein the sensing electrode configuration comprises a plurality of first sensing electrodes and a plurality of second sensing electrodes, each first sensing electrode has a first end and a second end, and each second sensing electrode has a third end and a fourth end;
estimating a plurality of first impedances between the first ends and a plurality of first conductive wires in a control end of the matrix resistive touch panel, a plurality of second impedances between the second ends and a plurality of second conductive wires in the control end, a plurality of third impedances between the third ends and a plurality of third conductive wires in the control end, and a plurality of fourth impedances between the fourth ends and a plurality of fourth conductive wires in the control end;
calculating a plurality of compensating impedances of the first impedances, the second impedances, the third impedances and the fourth impedances according to impedance differences of the first impedances, the second impedances, the third impedances and the fourth impedances; and
correspondingly adjusting the first impedances, the second impedances, the third impedances and the fourth impedances through the compensating impedances for equating the first impedances between the first ends and the control end, equating the second impedances between the second end and the control end, equating the third impedances between the third end and the control end, and equating the fourth impedances between the fourth end and the control end.

12. The design method according to claim 11, wherein the step of adjusting the first impedances, the second impedances, the third impedances and the fourth impedances comprises:
correspondingly adjusting the length and the cross-section area of respective of the first conductive wires, the second conductive wires, the third conductive wires and the fourth conductive wires according to the compensating impedances.

13. The design method according to claim 11, wherein the step of adjusting the first impedances, the second impedances, the third impedances and the fourth impedances comprises:
lapping the first conductive wires to a first voltage-drop element, lapping the second conductive wires to a second voltage-drop element, lapping the third conductive wires to a third voltage-drop element, and lapping the fourth conductive wires to a fourth voltage-drop element according to the compensating impedances.
